(19) United States
(12) Patent Application Publication
(10) Pub. No.: US 2024/0375911 A1
(43) Pub. Date: Nov. 14, 2024

(54) APPARATUS AND METHOD FOR ELEVATOR CONTROL UTILIZING LOGARITHMIC AVERAGING FOR CONSISTENT LEVELING TIMES

(71) Applicant: Smartrise Engineering, Inc., Irving, TX (US)

(72) Inventors: Gilbert Zogbi, Irving, TX (US); Thomas Hanger, Grapevine, TX (US)

(73) Assignee: Smartrise Engineering, Inc., Irving, TX (US)

(21) Appl. No.: 18/661,596

(22) Filed: May 11, 2024

Related U.S. Application Data
(60) Provisional application No. 63/502,095, filed on May 13, 2023.

(51) Int. Cl. B66B 1/40; B66B 1/24; B66B 1/34; B66B 9/04

(52) U.S. Cl. CPC B66B 1/405; B66B 1/24; B66B 1/3492; B66B 9/04

(57) ABSTRACT

An apparatus and method for controlling a hydraulic elevator system involves setting a baseline slowdown distance based on initial tuning, establishing a target leveling time in 0.1-second intervals, monitoring elevator operations to capture high speed, transition distance, leveling speed, leveling distance data, and adjusting the reference slowdown distance to align actual leveling times with the target time. A logarithmic averaging method is employed to calculate the reference slowdown distance, ensuring consistent elevator performance by smoothing out data variations.

### CROSS-REFERENCE TO RELATED APPLICATIONS

This application claims priority benefit from U.S. Provisional Application No. 63/502,095, filed on May 13, 2023. The patent application identified above is incorporated here by reference in its entirety to provide continuity of disclosure.

### FIELD OF THE INVENTION

The present invention relates to control systems for hydraulic elevators, specifically to methods and systems for dynamically adjusting elevator deceleration to enhance leveling accuracy and ride quality. The invention addresses the need for improved consistency in elevator leveling times by implementing adaptive control techniques that adjust operational parameters based on real-time performance data. This invention is particularly relevant in the field of elevator technology, where precision in stopping at designated floors significantly impacts passenger comfort, operational efficiency, and safety. The adaptive approach allows for finer control over elevator movements, catering to varying loads and operational conditions.

### BACKGROUND OF THE INVENTION

Various methods have been employed in the past to control hydraulic elevator systems, with a focus on optimizing the leveling process to enhance passenger comfort and operational efficiency. Traditionally, elevator control systems have utilized fixed baseline slowdown distances determined during initial tuning to regulate the elevator's deceleration as it approaches the target floor. However, these fixed distances may not always result in precise leveling times, leading to inconsistencies in elevator performance and potentially causing discomfort to passengers during the leveling process.

In some existing approaches, target leveling times for elevators have been defined in discrete increments to guide the leveling process. These target times are typically set based on empirical data and engineering considerations to achieve a balance between operational speed and passenger comfort. While this method provides a general framework for elevator control, it may not account for real-time operational variations that can impact the actual leveling times experienced by passengers. As a result, there is a need for a more adaptive approach that can dynamically adjust the reference slowdown distance based on real-time operational data to improve the accuracy of leveling times.

Monitoring the operation of hydraulic elevator systems during each run to capture operational data, such as high speed, leveling speed, and elevator car position has been a common practice in the field. This data is crucial for analyzing the performance of the elevator system and identifying areas for improvement. However, conventional methods of adjusting the reference slowdown distance based on this operational data may not always provide optimal results, as they may not effectively account for variations in the data that can impact elevator performance.

U.S. Pat. No. 4,726,450 to Fossati, et al., introduces a hydraulic elevator system with a dynamically controlled flow valve. This valve is operated by a stepper motor, which adjusts the flow to the actuator, thereby controlling the elevator car's speed and velocity profile. The system adapts to various factors, including load and fluid characteristics, to ensure precise movement and smooth operation. This patent does not focus solely on leveling time adjustments, but manages the velocity profile during ascent and descent, incorporating feedback loops to account for fluid viscosity and load, ensuring comprehensive control and performance.

U.S. Pat. No. 11,518,650 to Wilczak, et al., presents a system for monitoring and managing elevator performance attributes. The system leverages sensors affixed to the elevator car to collect data on key performance metrics, such as travel time and door vibrations. This data is compared to a threshold profile, which varies based on factors like floor location and door weight. This patent does not focus solely on leveling time adjustments, but rather employs analytics such as statistical analysis and clustering algorithms to tailor performance thresholds to the specific elevator system.

U.S. Pat. No. 10,112,801 to Madarasz, et al., presents a system for analyzing elevator performance. It consists of a separate sensor package and a computing device. The sensor package, affixed to an elevator car, measures parameters like acceleration, altitude, and door position. This data is sent to a computing device, which processes and analyzes it, providing metrics such as speed, jerk, vibration, and door timings. The patent discusses a variety of elevator attributes and how they can be measured and reported but does not solve the problems and leveling adjustments.

U.S. Pat. No. 9,828,210 to Celik, et al., describes a control device that adjusts an inverter's output variable to regulate the speed of a hydraulic pump in an elevator system. The system includes a computing module that modifies the inverter's output based on captured torque and fluid temperature, ensuring smooth elevator operation. This system dynamically compensates for variations in fluid temperature and pressure loss. It corrects speed deviations for both full and leveling phases to improve ride quality.

U.S. Pat. No. 4,976,338 to Holland provides a leveling system for hydraulic elevators. The system provides sensors that define dynamic dead zones, allowing management of the car's level based on operational states such as door status, time of day, and motor conditions. The controller also selects specific relevel target positions, either at floor level or slightly above, to reduce relevel cycles. This system focuses on leveling control rather than leveling time adjustments, minimizing fluctuations over time by addressing different operational parameters.

European Patent No. EP3841049A1 to provides a system for managing the performance of hydraulic elevators. The system utilizes sensors and a control module to monitor real-time parameters such as fluid temperature, load variations, and door timings. It compares these parameters to a threshold profile that adjusts based on operational variances, ensuring consistent leveling and releveling cycles. This invention adjusts thresholds to maintain consistent and accurate leveling, reducing fluctuations caused by fluid and load variations throughout the elevator's journey.

Therefore, there remains a demand for a method that can utilize advanced data processing techniques, such as logarithmic averaging, to calculate the reference slowdown distance in a manner that smooths out data variations and ensures consistent elevator performance.

### SUMMARY OF THE INVENTION

To address these challenges, the current disclosure proposes a novel approach to hydraulic elevator control. The solution delivers consistent and accurate speeds for both full and leveling movements, increasing efficiency, and enhancing ride quality. By balancing performance, simplicity, and cost-effectiveness, this approach delivers reliable operation, smooth stops, and accurate leveling to meet passenger expectations.

The elevator control system consists of multiple controller boards, the various subsystems ensure comprehensive control over the elevator's movement, safety, and operational efficiency.

The central controller board manages various aspects of the elevator's operation. It connects directly to the 120V AC power line, 24V DC inputs, and outputs, handling signals from various sources. The board includes navigation buttons for accessing its menu and resetting specific functions. It also connects to safety string inputs, enabling emergency stops when needed.

The car panel controller oversees the car's operating panel and various other controls. It receives signals from the central controller board and sends commands to manage door operations, car call buttons, and other safety mechanisms. The car logic controller works in tandem with the car panel controller board, issuing commands for door operations, speed regulation, and safety checks.

The hall panel controller manages signals from hall call buttons and landing sensors, connecting directly to the central controller board. This board helps regulate car stops, door operations, and landing accuracy. The central controller board receives signals from the Hall Board and uses them to ensure accurate landing positions and efficient door operations, maintaining smooth passenger flow.

The motion controller manages the hydraulic valve and motion that controls the elevator car's movement. It receives commands from the central controller board, regulating the flow of hydraulic fluid to the cylinder, thereby controlling the car's ascent and descent. This connection ensures that the system maintains consistent speeds for both full and leveling movements.

Overall, the system's controller boards work together seamlessly, balancing operational control, safety, and redundancy. The interconnections between these boards provide comprehensive management of the elevator's functions, optimizing its performance and ensuring reliable, safe operation.

In addition to the specific functions outlined, the system integrates advanced technologies, such as the adaptive slowdown feature ensuring consistent ride quality. By processing signals from various sources and recursively calculating leveling times and slowdown positions, the system maintains smooth operations, minimizing travel time and enhancing passenger comfort.

The adaptive slowdown feature is a dynamic feature which enhances the operation of the hydraulic elevator. This feature optimizes the elevator's deceleration, improving ride quality and ensuring smooth, time efficient stops.

The adaptive slowdown feature recursively adjusts the elevator's deceleration parameters based on real-time data and pre-established benchmarks. For example, the system dynamically sets slowdown positions for the elevator car, ensuring a smooth transition from full speed to leveling speed. By continuously monitoring and comparing the elevator's speed and position to the target values, the system makes precise adjustments to the deceleration curve. The adaptive slowdown feature also manages threshold adjustments, allowing for fine-tuning of the slowdown process.

The adaptive slowdown feature enhances the elevator's performance by providing dynamic deceleration control, consistent leveling times, and improved ride quality. The system ensures smooth operations, minimizing travel time inconsistencies and enhancing overall efficiency.

### BRIEF DESCRIPTION OF THE DRAWINGS

In the detailed description of the preferred embodiments presented below, reference is made to the accompanying drawings.

FIG. 1 is a schematic illustration of a preferred elevator system.

FIG. 2 is an architecture drawing of a preferred elevator control system.

FIG. 3A is a schematic drawing showing various distances and elevator functions of a car proceeding in an “up” direction.

FIG. 3B is a schematic drawing showing various distances and elevator functions of a car proceeding in a “down” direction.

FIG. 4 is an exemplary graph of elevator car velocity versus time during a single run.

FIGS. 5A and 5B are a flow chart of an operational method for a preferred system.

FIG. 6 is a flow chart of a preferred determined slowdown position subroutine.

FIG. 7 is a flow chart of a preferred method of a monitor subroutine.

FIG. 8 is a flow chart of a method of a preferred post movement subroutine.

FIG. 9 shows plots of a slowdown distance average versus a comparison simple average for slowdown data samples for a ramp up example.

FIG. 10 shows plots of a slowdown distance average versus and a comparison simple average for slowdown data samples for a single event example.

FIG. 11 shows plots of a slowdown distance average versus and a comparison simple average for slowdown data samples for a noise tracking example.

### DETAILED DESCRIPTION OF THE INVENTION

In the description that follows, like parts are marked throughout the specification and figures for the same numerals. The figures are not necessarily drawn to scale and may be shown in exaggerated or generalized form in the interest of clarity and conciseness. Unless otherwise noted, all tolerances and uses of the term “about” indicate plus or minus 20%.

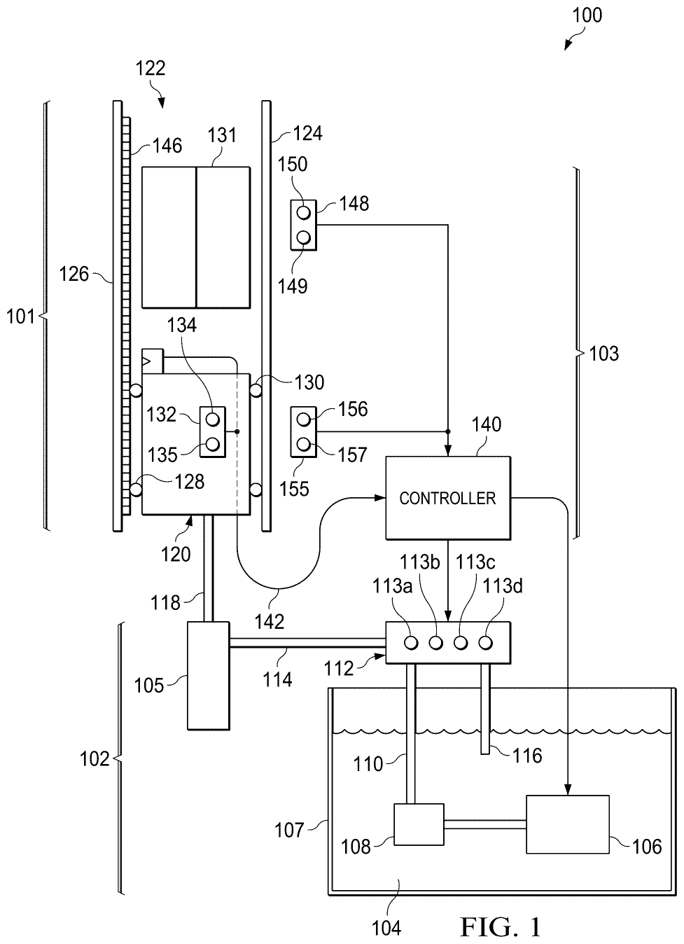

Referring to FIG. 1, elevator system 100 will be further described.

Elevator system 100 includes mechanical system 101, hydraulic system 102 and controller system 103.

Mechanical system 101 includes car 120 movably disposed within shaft 122.

Shaft 122 is made up of a plurality of rails, such as rails 124 and 126. Car 120 is guided up and down shaft 122, along rails 124 and 126 by a plurality of guide wheels 128 and 130. Mechanical doors, such as doors 131, are positioned adjacent to shaft 122 at each floor level.

Hydraulic system 102 includes electric motor 106, which may be an induction motor, such as an asynchronous AC motor. Motor 106 is mechanically coupled to hydraulic pump 108. Hydraulic pump 108 is preferably a low pulsating screw pump. Pump 108 is connected to hose 110. Hose 110 is connected to hydraulic valve 112. Hydraulic valve 112 includes high speed up valve 113a, low speed up valve 113b, high speed down valve 113c, and low speed down valve 113d. Hydraulic valve 112 is connected to hydraulic cylinder 105 by hose 114. Hydraulic cylinder 105 includes movable piston rod 118. Elevator car 120 is supported by piston rod 118. Hydraulic valve 112 is connected to hose 116 for returning fluid to tank 107. Motor 106 and pump 108 are typically submersed in hydraulic fluid in reservoir 104, as are supply hose 110 and hose 116.

When motor 106 is activated, pump 108 forces fluid, under high pressure, through hydraulic valve 112 and hose 114 into cylinder 105. Fluid pressure from hose 114 in the cylinder raises the piston rod, and car 120. Likewise, lowering car 120 forces the piston rod back into the cylinder and so also forces fluid from cylinder 105 through hose 114, and valve 112, into tank 107, through hose 116.

Control system 103 includes controller 140, car panel controller 132, control panels 148 and 155 and sensor 144.

Car panel controller 132 includes control buttons 134 and 135, and circuitry used to open and close the car doors (not shown). Control buttons 134 and 135 are used to instruct the car as to the destination and direction of travel of the car. Car panel controller 132 is operatively connected to controller 140 through umbilical cord 142.

Sensor 144 is operatively connected to car panel controller 132, adjacent tape 146. Preferably, the sensor is an optical sensor. Tape 146 is rigidly fixed longitudinally inside shaft 122 and includes a printed code or gradations that indicate vertical position in the shaft. In use, sensor 144 records elevator velocity and position by constantly examining tape 146, and sending data back to controller 140, as is known in the art.

Control panels 148 and 155 are fixed externally to shaft 122. Control panel 148 includes up button 150 and down button 149. Likewise, control panel 155 includes up button 156 and down button 157. Both control panel 148 and control panel 155 are operatively connected to controller 140. The control panels send “call” signals to the controller, as will be further described.

Controller 140 is also operatively connected to hydraulic valve 112 and motor 106. In operation, a passenger request signal for moving car 120 in the up or down directions, to a specific destination, is received at car panel controller 132 or control panels 148 or 155. The request signal is sent to controller 140. Upon receipt of the signal, controller 140 conducts a number of calculations, which control movement of car 120, as will be further described.

For example, upon receiving a command to move to a destination in an “up” direction from one of the control panels, controller 140 activates motor 106, and opens high speed up valve 113a and low speed up valve 113b. Motor 106 drives pump 108 to force high pressure hydraulic fluid from reservoir 104 into cylinder 105, which forces piston rod 118 and car 120 upward. Further, by monitoring sensor 144, controller 140 closes the valves and stops the motor, in a specific order, when car 120 has arrived at its destination, as will be further described.

Likewise, upon receiving a command to move to a destination in a “down” direction, from one of the control panels, controller 140 opens high speed down valve 113c and low speed down valve 113d. These valves allow fluid from cylinder 105 to re-enter reservoir 104, thus lowering car 120. Upon reaching its destination, as indicated by sensor 144, the controller closes these valves, in a specific order, as will be further described.

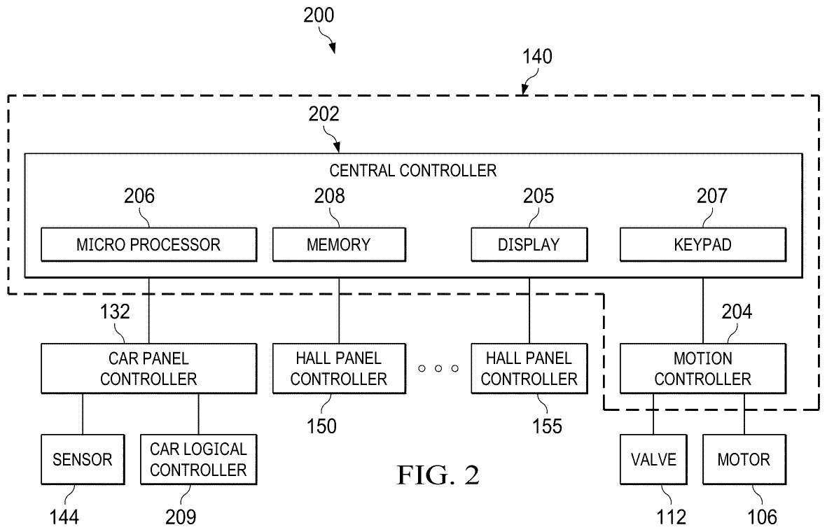

Referring to FIG. 2, a schematic overview of control system 200 will be further described.

Central controller 202 includes microprocessor 206 operatively connected to memory 208. Memory 208 includes instructions, that when executed by microprocessor 206 cause the system to function, as will be further described. The central controller further includes display 205 and keypad 207, both operatively connected to the microprocessor. The keypad is used to provide instructions and data to the microprocessor. The display is used for the microprocessor to indicate the current status of the system and show the values of various operational parameters of the system. Preferably, central controller 202 is the MR Board SR3032, available from Smartrise Engineering, Inc. of Irving, Texas.

Central controller 202 is operatively connected to motion controller 204. Motion controller 204 is further operatively connected to valve 112 and motor 106. Motion controller 204 receives command signals from central controller 202 and is responsible for activating and deactivating the motor and valves which results in raising and lowering car 120. Preferably, motion controller 204 is Valve Board SR3045, available from Smartrise Engineering, Inc. of Irving, Texas.

Central controller 202 is further operatively connected to a number of hall panel controllers, such as hall control panels 148 and 155. In one embodiment, central controller 202 supports up to 32 hall control panels. The hall control panels receive signals from hall call buttons and transmits them directly to the central controller, as will be further described.

Central controller 202 is further connected to car panel controller 132. Car panel controller 132 receives signals from call buttons and other safety mechanisms and passes them directly to central controller 202. Car panel controller 132 is operatively connected to sensor 144. The car panel controller receives signals from sensor 144 related to the car's position and velocity, and passes them directly to central controller 202, as will be further described.

Car panel controller 132 is further connected to car logic controller 209. Car logic controller 209 generates and sends control signals which regulate opening and closing the car doors (not shown). Car logic controller 209 is preferably the CLC Board available from Smartrise Engineering, Inc. of Irving, Texas.

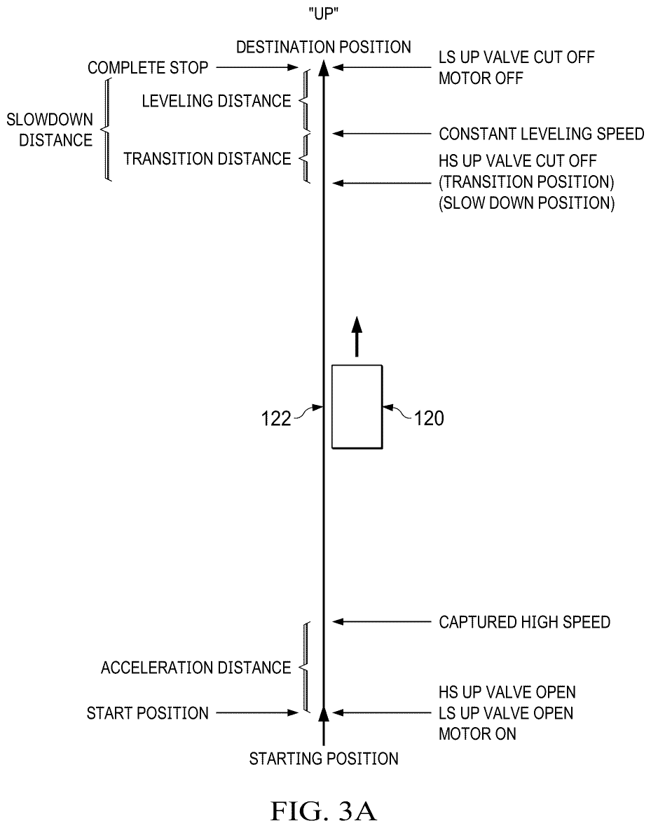

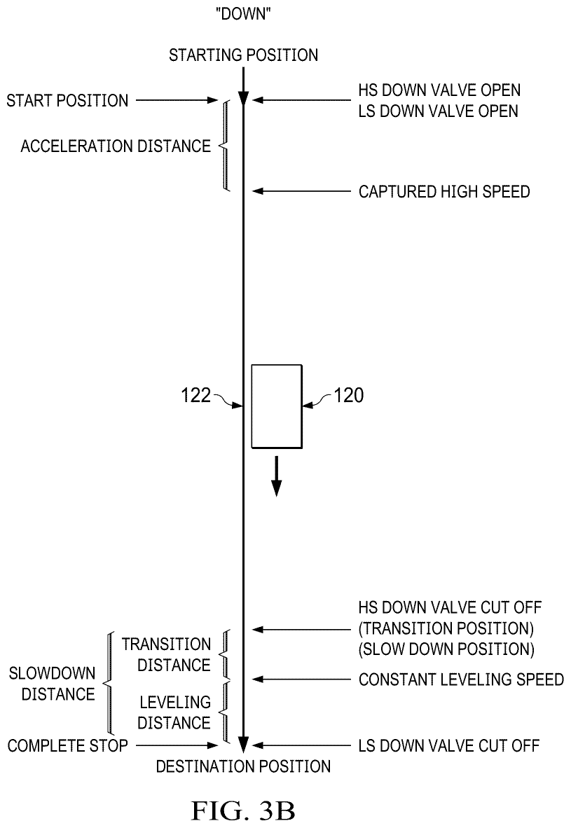

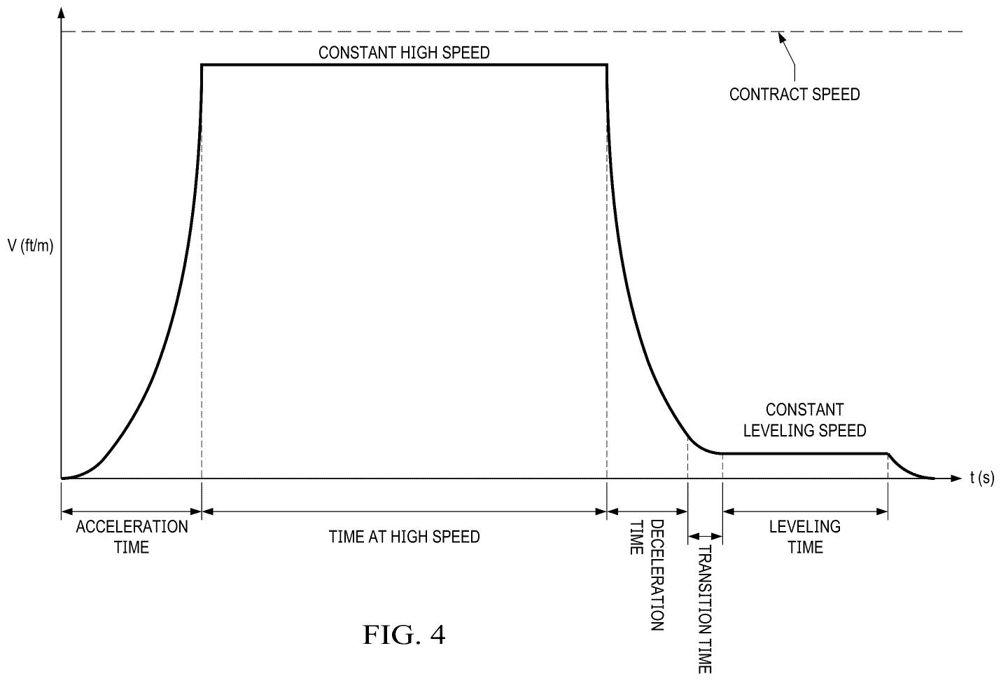

Referring to FIGS. 3A, 3B, and 4, the movement of elevator car 120 will be further described.

In each case, at the starting position, the velocity of the elevator car is zero. At the starting position, both the high speed and low speed valves are closed and the motor is off.

Upon receiving a signal from one or more of the control panels, the controller sends the signals to the hydraulic valve and the motor which moves the elevator car.

As shown in FIG. 3A, if the destination is in the up direction, the controller opens the high speed up valve and the low speed up valve and turns the motor on. Upon reaching the transition position, the controller closes the high speed up valve thereby throttling the amount of hydraulic fluid reaching the piston. Upon reaching the destination the elevator car comes to a complete stop and the controller closes the low speed up valve and turns the motor off.

Referring to FIG. 3B, if the destination is downward, the controller opens both the high speed down valve and low speed down valve. Upon reaching the transition position, the high speed down valve is closed, thereby throttling the amount of fluid that can return from the hydraulic cylinder to the tank. Upon reaching the destination, the controller closes the low speed down valve and the elevator car comes to a complete stop.

Referring to FIG. 4, in operation, the elevator car accelerates from zero velocity to a constant high speed over an acceleration time. The car maintains this constant high speed for a finite time, until it reaches the slow-down position or “transition position.” The constant high speed should always be below the maximum speed of the elevator set during installation known as the “contract speed.” Upon reaching the transition position, the elevator car begins to decelerate from the constant high speed, through the deceleration time, toward the constant leveling speed. The elevator car moves through a transition distance when its velocity is between the constant high speed and the constant leveling speed during the transition time. After the transition distance, the elevator car reaches a constant leveling speed, and stays at this constant leveling speed, throughout the leveling distance, during the leveling time. After the leveling time, the car comes to a complete stop at the destination. The transition distance plus the leveling distance is known as the “slowdown distance.”

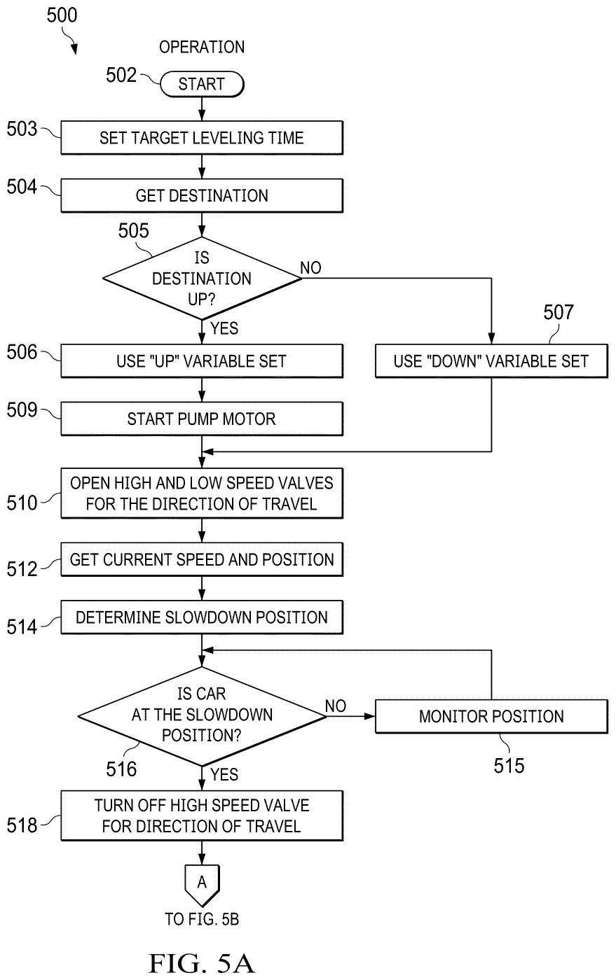

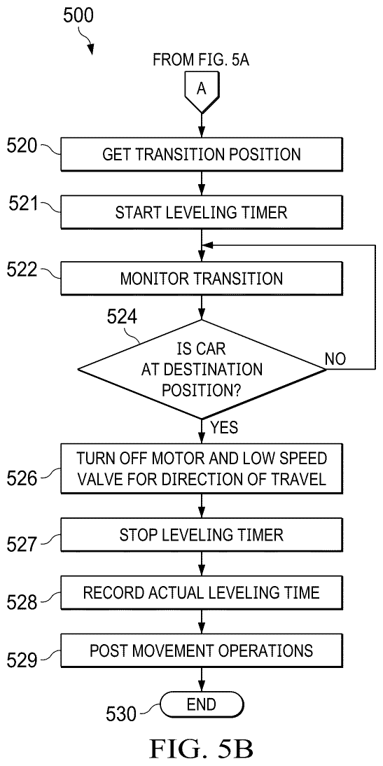

Referring then to FIGS. 5A and 5B, method 500 of system operation will be further described. Preferably, method 500 is achieved through software, resident in memory 208, which controls the operation of microprocessor 206. In general, method 500 monitors the operation of each of the elevator during each run and collects data for many parameters. After each run, it adjusts a reference slowdown distance variable based upon previous runs, so that subsequent runs result in leveling times closer to the target leveling time.

At step 502, the method begins.

At step 503, the microprocessor receives a target leveling time as input. Preferably, the target leveling time is about 3 seconds, and is received in about 0.1 second intervals.

At step 504, the microprocessor retrieves the destination position from one of the control panels.

At step 505, the method determines whether or not the destination of the elevator car is “up.” If so, the method moves to step 506. If not, the method moves to step 507.

At step 506, the microprocessor elects the “up” variable set. A separate variable set for each of the variables, including high speed, slowdown position, transition position, leveling time, slowdown distance, transition distance, leveling distance, override and slowdown sum is maintained in memory in a separate variable set for each of the “up” and “down” directions of car travel. The method operates independently with each variable set. As a result, the slowdown positions and the leveling times may be different for the same destination depending on the direction of car travel.

At step 507, the microprocessor elects the “down” variable set and moves to step 510.

At step 509, the microprocessor starts the pump motor.

At step 510, the microprocessor opens both the high and low speed valves for the direction of travel. For example, if the direction of travel is up, then high speed up value 113a and low speed up value 113b are opened. If the direction of travel is down, then high speed down value 113c and low speed down value 113d are opened.

At step 512, the microprocessor polls sensor 144 to determine the current speed and position of the car.

At step 514, the microprocessor determines the slow-down position with a separate subroutine, as will be further described.

At step 516, the microprocessor determines whether or not the car is at the slow-down position. If not, the microprocessor moves to step 515. If so, the microprocessor moves to step 518.

At step 515, the microprocessor monitors sensor 144 to determine the position of the car, and then returns to step 516.

At step 518, the microprocessor turns off the high speed valve for the direction of travel.

At step 520, the microprocessor retrieves the car position from sensor 144.

At step 521, the microprocessor starts a “leveling timer.” The leveling timer is an elapsed real time counter that is used to store the leveling time for each run in 0.1 second intervals.

At step 522, the microprocessor monitors the transition distance, as will be further described.

At step 524, the microprocessor again polls the sensor to determine whether or not the car is at the destination. If not, the microprocessor returns to step 522. If so, the microprocessor moves to step 526.

At step 526, the microprocessor turns off the motor and closes the low speed valve for the direction of travel.

At step 527, the microprocessor stops the leveling timer.

At step 528, the microprocessor records the elapsed leveling time in a current leveling time variable in memory in the appropriate “up” or “down” variable set for later use.

At step 529, the microprocessor conducts post-movement operations with a separate subroutine, as will be further described.

At step 530, the method concludes.

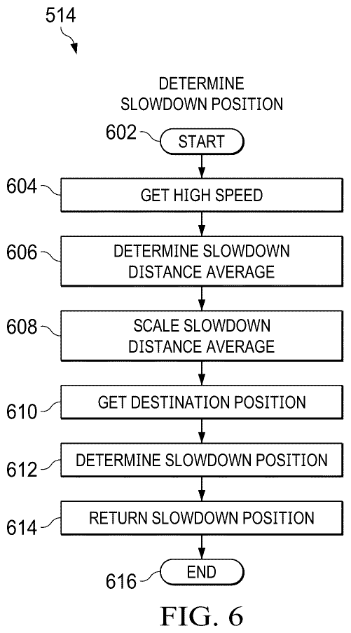

Referring then to FIG. 6, the method of step 514 will be further described.

At step 602, the method begins.

At step 604, the microprocessor retrieves the high speed of the car recorded at step 512.

At step 606, the microprocessor determines the slowdown distance average according to the following equation:

$$slowdown distance average = \frac{slowdown {sum}^{′}}{slowdown sum factor}$$

$$Where : slowdown sum factor = 8 ;$$

$$slowdown {sum}^{′} = logarithmic accumulation variable .$$

In one embodiment, the slowdown sum factor is the integer “8.” The slowdown sum factor effects the number of samples over which the logarithmic averaging is effective. It can take on other integer values in other embodiments.

At step 608, the microprocessor scales the slowdown distance average according to the following equation.

$$slowdown distance {average}^{′} = slowdown distance average \times ( \frac{high speed}{contract speed} )$$

$$Where : contract speed = maximum elevator car speed ;$$

$$high speed = highest speed during current elevator car run .$$

At step 610, the microprocessor retrieves the destination value as stored in memory at step 504.

At step 612, the microprocessor determines the slowdown position according to the following equation.

$$slowdown position = destination position - slowdown distance {average}^{′}$$

At step 614, the method returns the slowdown position, and the slowdown distance average'.

At step 616, the method concludes.

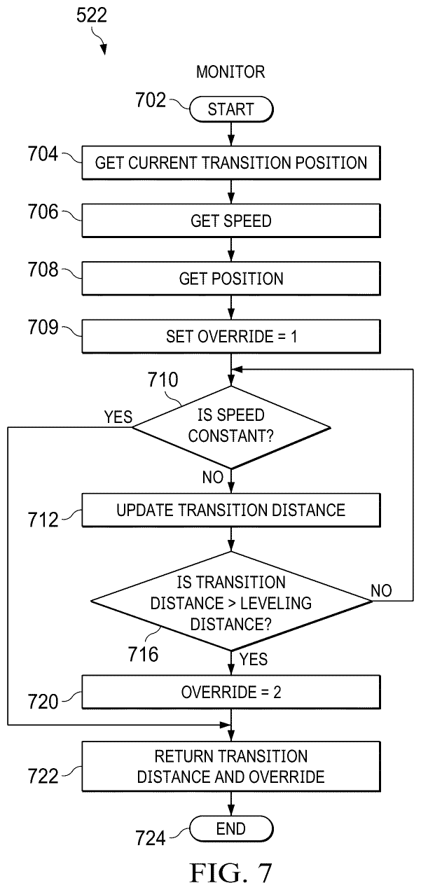

Referring to FIG. 7 the method of step 522 will be further described.

At step 702, the method begins.

At step 704, the method retrieves the current transition position. The transition position is the position at which the high speed valve is deactivated as setout at step 520.

At step 706, the microprocessor polls sensor 144 to determine the current speed of the car.

At step 708, the microprocessor again polls the sensor to determine the current position of the car.

At step 709, the microprocessor sets the override variable to an integer value “1.”

At step 710, the microprocessor determines whether or not the speed of the car is constant. Preferably, the microprocessor determines whether or not the speed is constant by recording at least two consecutive velocity readings from the sensor and comparing them for equality. If not, the method moves to 712. If so, the method moves to step 722.

At step 712, the microprocessor updates the transition distance. The transition distance is updated according to the following equation:

$$new transition distance = the current position - current transition position$$

$$Where : transition position = the position of the car at high speed valve cut off .$$

At step 716, the microprocessor determines whether or not the new transition distance is greater than the leveling distance. If not, the microprocessor returns to step 710. If so, the method moves to step 720.

At step 720, the microprocessor sets an override variable to the integer “2” and moves to step 722. The override variable addresses the rare situation where the car reaches its destination before it can reach a constant leveling speed. This situation is to be avoided because it leads to abrupt stops. To do so, the override variable is used to double the adjusted slowdown distance in the logarithmic averaging equation, as will be further described. In the normal situation, the transition distance is less than the leveling distance and so no modification is needed to the logarithmic average equation, as indicated by the override variable being equal to “1,” as has been previously described.

At step 722, the method returns transition distance, leveling timer value, and the override variable value.

At step 724, the method concludes.

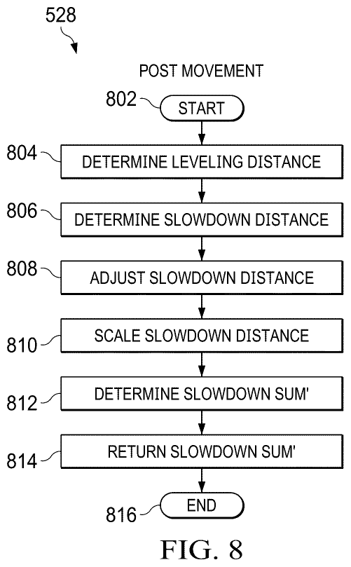

Referring then to FIG. 8 the method of step 528 will be further described.

At step 802, the method begins.

At step 804, the method determines the leveling distance according to the following equation.

$$leveling distance = ( current postion - current transition position ) - new transition distance$$

At step 806, the method determines a slowdown distance according to the following equation:

$$slowdown distance = current position - current transition position$$

$$Where : current position = destination position .$$

At step 808, the method adjusts the slowdown distance according to the following equation:

$$slowdown {distance}^{′} = slowdown distance \times ( \frac{target leveling time}{actual leveling time} )$$

$$Where : actual leveling time is recorded at step 528 and the target leveling time is entered at step 503.$$

As can be seen, this step is used to increase the slowdown distance when the actual leveling time is below the target leveling time and decrease the slowdown distance when the actual leveling time is above the target leveling time.

At step 810, the method scales the slowdown distance according to the follow equation.

$$slowdown {distance}^{″} = slowdown {distance}^{′} \times ( \frac{contract speed}{high speed} )$$

As can be seen, this step is used to increase the slowdown distance when the contract speed is above the high speed and decrease the slowdown distance when the contract speed is below the high speed.

At step 812, the method determines the slowdown sum according to the following equation.

$$slowdown {sum}^{′} = ( slowdown sum - slowdown distance {average}^{′} ) + ( slowdown {distance}^{″} \times override variable )$$

The slowdown sum′ variable is an accumulation variable that produces a recursive filter which programmatically simulates logarithmic averaging. As can be seen, this step is used to accomplish logarithmic averaging by continuously adjusting the slowdown sum by subtracting the current slowdown distance average from the slowdown sum accumulation variable, and then adding the adjusted slowdown distance, as the new sample, derived in step 810. This step has the effect of smoothing out variations in the slowdown sum and the slowdown position.

At step 814, the method returns the slowdown sum′ accumulation variable.

At step 816, the method concludes.

In practice, the adaptive slowdown system is a parameter to define a target leveling time preferably in 0.1 second increments. The system monitors the operation of the elevator on each run. After each run it adjusts a reference slowdown distance variable based on previous runs so that subsequent runs result in leveling times closer to the target leveling time.

The adjustment of the slowdown distance is gradual. Run-to-run variation in elevator operations do not have a significant effect on the reference slowdown distance.

The slowdown distance determines when to close the high speed valve. The slowdown distance is the sum of the transition distance plus the leveling distance for the direction of travel. This slowdown distance is scaled based on the contract speed and the high speed. The slowdown distance is also adjusted based on the difference between the target leveling time and the actual leveling time.

After adjustment, the slowdown distance is added to the difference between the slowdown sum variable and the slowdown distance average to produce a desired slowdown sum from the run. The new slowdown sum value is used to calculate the new slowdown position for the direction of travel.

Occasionally, a condition can occur where the slowdown distance used is too small to allow the car to reach leveling speed before it reaches the destination position. When this condition occurs, a value of twice the current slowdown distance is added to the slowdown sum variable. Hence, the system is self-correcting because it increases the slowdown distance for subsequent runs so that the car will slow to leveling speed more quickly and can then be adjusted into the target leveling time. If this condition occurs too frequently, then the target leveling time is too small for the mechanics of the system and so the target leveling time should be increased.

The slowdown distance sum is calculated using a “logarithmic average” process.

By comparison, to derive a simple average, several samples are added together and divided by the number of samples.

A logarithmic average accumulates a running sum of samples in a single variable, which is constantly adjusted to a new value.

To add a new sample to the sum, the current average is subtracted from the sum variable and the new sample is added to the resulting new sum variable.

The logarithmic average tracks a constant change along a logarithmic curve. A single large change in one sample value will have an effect on the logarithmic average but will quickly recover if the subsequent samples have consistent values. This produces a filtering effect which smooths out inconsistent or “noisy” samples.

A software implementation of a logarithmic average requires a running sum variable. An average value is obtained by dividing the running sum variable by an integer factor, here the factor “8” is used. A new sample is added to the running sum variable with the following sequence: (1) Obtain the factored average value of the running sum and subtract it from the running sum variable; (2) Add the new sample to the running sum variable. The logarithmic average achieves a smoothing effect on the samples which aids in controlling noise and alienating abrupt changes in slowdown position.

By contrast, a software implementation of the simple average requires a simple array and a pointer to successively add samples to the array. The array is a finite first-in-last-out buffer. The simple average is computed by adding all the sample values currently in the buffer and dividing the result by the number of positions in the buffer.

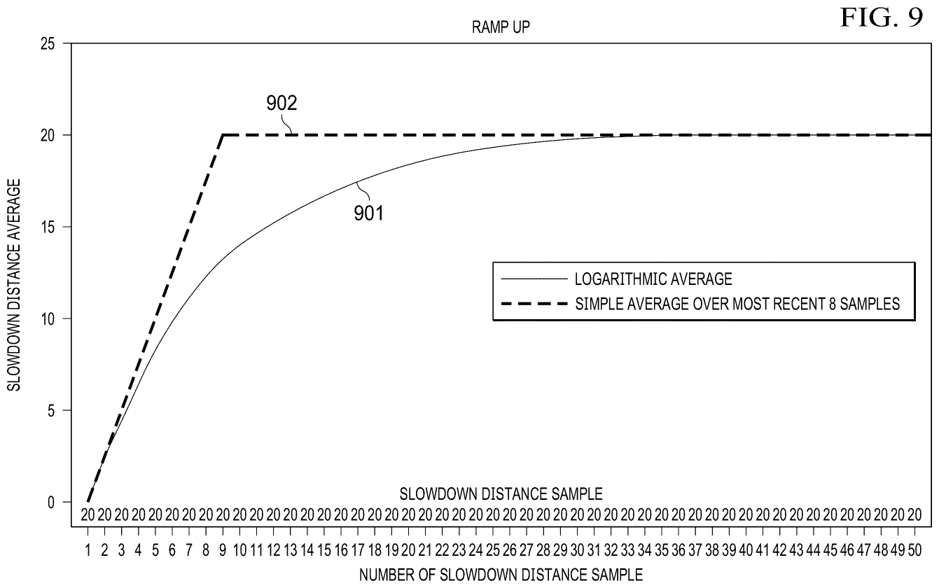

Referring then to FIG. 9, example plots of the slowdown distance average using the disclosed logarithmic average technique and a simple average technique are shown. As previously described, the slowdown distance average is determined by dividing the slowdown sum by the slowdown sum factor. The slowdown sum is derived by logarithmic averaging as shown at step 812, by subtracting the slowdown distance average from the slowdown sum and then adding the new slowdown distance value after each elevator run. The slowdown distance average is used to determine the new slowdown position for the next elevator run, as further described at step 612.

FIG. 9 depicts plots resulting from an example of the control system upon ramp up. For this example, the slowdown distance for each elevator run, of a series of 50 elevator runs, is exactly 20 inches.

As can be seen from plot 901, the logarithmic average result of the system asymptotically approaches a slowdown distance average equal to 20. The effect is that the slowdown position is gradually changed so as to encourage efficient and smooth operation of the elevator car upon landing.

By comparison, curve 902 shows a simple average over the most recent eight samples of slowdown distance. The simple average according to the following equation:

$$slowdown distance simple average = {\sum }_{{N}^{1}}^{{N}^{9}} \frac{slowdown {distance}_{N}}{8}$$

Curve 902 can be seen to rise at a fixed slope reaching a maximum of 20 after an abrupt transition at sample nine.

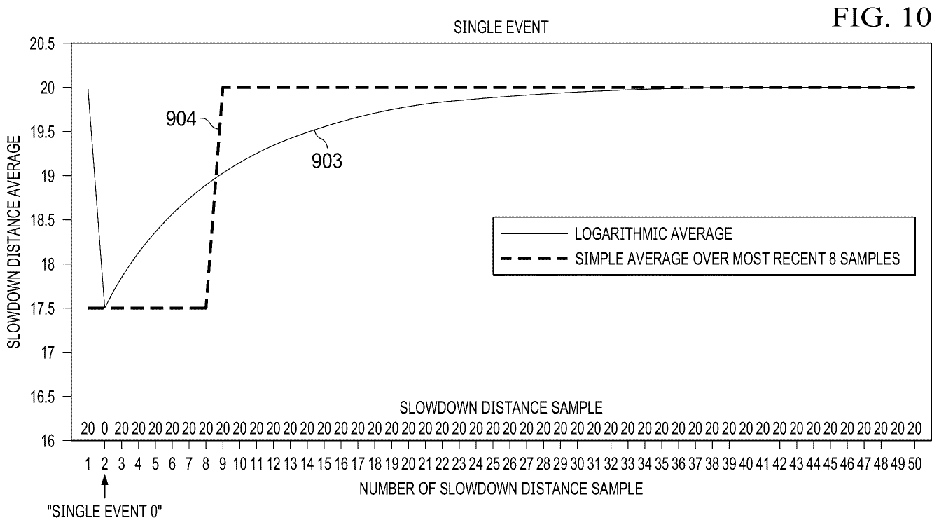

Referring then to FIG. 10, a second example will be discussed where a single sample of “0” is introduced into a constant string of sample values of “20”, at data position 2.

Logarithmic average curve 903 indicates a strong response in slowdown distance average from 20 to 17.5. The logarithmic average curve 903 then responds asymptotically approaching the slowdown distance average value of 20 over the next 48 samples.

By contrast, simple average curve 904 maintains a slowdown distance average of 17.5 for 8 entries of new slowdown samples until the 0-value sample drops out of the slowdown distance average, at sample event nine.

In practice, the elevator system using the logarithmic average method would slowly adjust to the slowdown distance average thereby slowly adjusting the slowdown position over a number of elevator runs. Conversely, simple average curve 904 shows that the elevator system would abruptly change slowdown distance averages at sample 8 and therefore abruptly change slowdown positions between car runs 8 and 9.

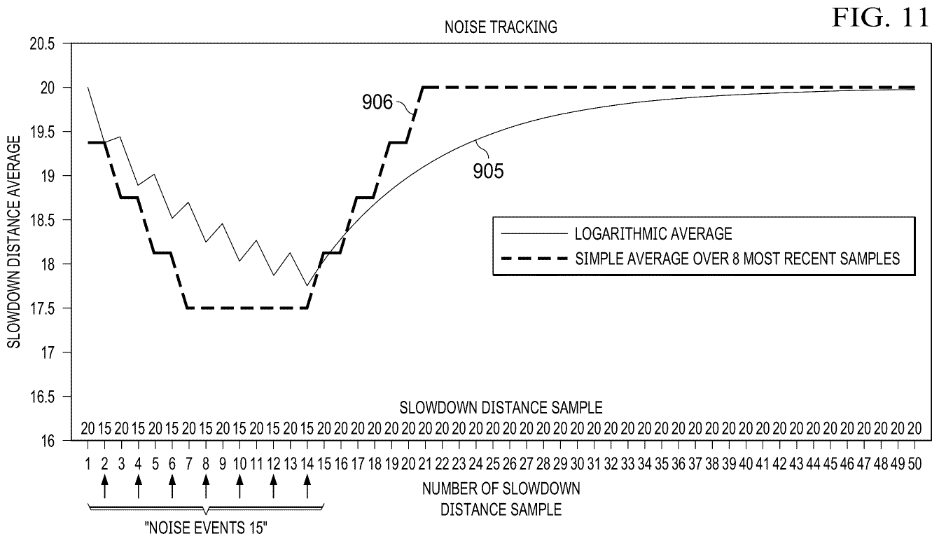

Referring then to FIG. 11, an example depicting noise tracking will be further described.

In this example, small but frequent variations in sample values are tracked differently between the two average types. In this example, samples alternate between 15 and 20 for the first 14 data positions, thereafter, returning to a stable sample value of 20 for positions 15 through 50.

Logarithmic average curve 905 shows a triangular response to each noise event dropping to a value of about 17.7 at event 14. From event 14 to event 50, logarithmic average curve 905 asymptotically approaches a stable value of 20. Conversely, simple average curve 906 accumulates a negative stair step bias upon the occurrence of each noise event 2, 4 and 6, retaining a minimum value of 17.5 from event 7 to event 14. From event 14 to event 21, a positive stair step bias is demonstrated until reaching an abrupt transition to the value 20 at position 21.

As can be seen, logarithmic average does not respond to noisy samples in the system as drastically as the simple average plot. Moreover, logarithmic average smooths data transition from the period of noise events to a stable value, avoiding an abrupt transition.

1. A control system for a hydraulic elevator, the hydraulic elevator including a car movably disposed in an elevator shaft, the car motivated by a hydraulic cylinder, which is operatively connected to a hydraulic pump, the hydraulic pump controlled by a set of valves and powered by a motor, the car including a motion sensor reporting a car speed and a car position in the elevator shaft, the control system comprising:
a processor, including a memory;
a valve controller, operatively connected to the set of valves and the processor,
a motor controller, operatively connected to the motor and the processor;
a control panel, operatively connected to the processor; and
the memory containing a set of instructions, that when executed cause the control system to:
receive a target leveling time;
receive a destination command identifying a destination position;
activate the set of valves to move the car;
determine a slowdown position using a logarithmic averaging algorithm scaled by the target leveling time;
monitor the car position to determine whether or not the car is at the slowdown position;
deactivate a high speed valve, of the set of valves, to slow the car if the car is at the slowdown position; and
deactivate a low speed valve, of the set of valves, to stop the car if the car is at the destination position.

2. The control system of claim 1, wherein the set of instructions further comprise instructions that when executed cause the control system to:
determine a transition distance, between a car high speed and a constant leveling speed, based on the car speed and the car position.

3. The control system of claim 2, wherein the step of determining the slowdown position further comprises:
determining whether or not the car has reached the constant leveling speed; and
updating the transition distance if the car has not reached the constant leveling speed.

4. The control system of claim 3, wherein the step of updating further comprises:
determining whether or not the transition distance is greater than a leveling distance, where the leveling distance is a current car position minus a transition position minus the transition distance.

5. The control system of claim 4, wherein the set of instructions further comprise instructions that when executed cause the control system to:
adjust the logarithmic averaging algorithm if the transition distance is greater than the leveling distance.

6. The control system of claim 1, wherein the step of determining the slowdown position further comprises:
retrieving a car high speed from the motion sensor;
determining a slowdown distance average based on a slowdown sum accumulation variable, in the logarithmic averaging algorithm, and a slowdown sum factor;
scaling the slowdown distance average using the car high speed and a contract speed to derive a scaled slowdown distance average; and
determining the slowdown position based on the scaled slowdown distance average and the destination position.

7. The control system of claim 6, wherein the slowdown sum factor is eight.

8. The control system of claim 6, wherein the step of determining the slowdown distance average further comprises:
determining a leveling distance;
determining a slowdown distance;
adjusting the slowdown distance based on the target leveling time and a measured leveling time to determine an adjusted slowdown distance;
scaling the adjusted slowdown distance, based on the car high speed and the contract speed, to determine a scaled slowdown distance; and
determining the slowdown sum accumulation variable using the logarithmic averaging algorithm and the scaled slowdown distance.

9. The control system of claim 8, wherein the step of determining the slowdown sum accumulation variable further comprises:
recursively filtering a slowdown sum by subtracting a logarithmic average of the slowdown distance from the slowdown sum and adding the scaled slowdown distance for each elevator run.

10. A control system for a hydraulic elevator, the hydraulic elevator including a car movably disposed in an elevator shaft, the car motivated by a hydraulic cylinder which is operatively connected to a hydraulic pump, the hydraulic pump controlled by a set of valves and powered by a motor, the car including a motion sensor reporting a car speed and a car shaft position, the control system comprising:
a processor, including a memory;
a valve controller, operatively connected to the set of valves and the processor,
a motor controller, operatively connected to the motor and the processor;
a control panel, operatively connected to the processor; and
the memory containing a set of instructions, that when executed cause the control system to:
receive a target leveling time;
receive a destination command to move the car to a destination position;
determine a direction of travel based on the destination command;
if the destination command is “up” then start the motor;
open a high speed valve, of the set of valves, and a slow speed valve, of the set of valves;
determine a slowdown position using a logarithmic averaging algorithm scaled by the target leveling time;
if the car is at the slowdown position, then deactivating the high speed valve;
monitoring a transition distance until the car reaches a leveling speed; and
deactivating the slow speed valve when the car reaches the destination position.

11. The control system of claim 10, wherein the step of determining the slowdown position further comprises:
determining a slowdown distance logarithmic average; and
determining the slowdown position from the destination position and the slowdown distance logarithmic average.

12. The control system of claim 11, further comprising instructions and when executed cause the control system to:
scale the slowdown distance logarithmic average by a high speed signal from the motion sensor and a contract speed.

13. The control system of claim 12, wherein the step of determining the slowdown distance logarithmic average further comprises:
determining a slowdown distance;
adjusting the slowdown distance by a first ratio of the target leveling time to an actual leveling time, to determine an adjusted slowdown distance;
scaling the adjusted slowdown distance by a second ratio of the contract speed and the high speed signal, to determine a scaled slowdown distance; and
calculating a new slowdown sum from a previous slowdown sum, the slowdown distance logarithmic average and the scaled slowdown distance.

14. The control system of claim 13, wherein the step of calculating further comprises:
doubling the scaled slowdown distance, if the transition distance is greater than a leveling distance.

15. A method for controlling a hydraulic elevator, the hydraulic elevator including a car movably disposed in an elevator shaft, the car motivated by a hydraulic cylinder, which is operatively connected to a hydraulic pump, the hydraulic pump controlled by a set of valves and powered by a motor, the car including a motion sensor reporting a car speed and a car position in the elevator shaft, the method comprising:
providing a processor, including a memory;
providing a valve controller, operatively connected to the set of valves and the processor,
providing a motor controller, operatively connected to the motor and the processor;
providing a control panel, operatively connected to the processor; and
providing the memory with a set of instructions, that when executed cause the processor to:
receive a target leveling time;
receive a destination command identifying a destination position;
activate the set of valves to move the car;
determine a slowdown position using a logarithmic averaging algorithm scaled by the target leveling time;
monitor the car position to determine whether or not the car is at the slowdown position;
deactivate a high speed valve, of the set of valves, to slow the car if the car is at the slowdown position; and
deactivate a low speed valve, of the set of valves, to stop the car if the car is at the destination position.

16. The method of claim 15, wherein the step of providing the memory with the set of instructions further comprises providing the memory with instructions that when executed cause the processor to:
determine a transition distance, between a car high speed and a constant leveling speed, based on the car speed and the car position.

17. The method of claim 16, wherein the step of determining the slowdown position further comprises:
determining whether or not the car has reached the constant leveling speed; and
updating the transition distance if the car has not reached the constant leveling speed.

18. The method of claim 17, wherein the step of updating further comprises:
determining whether or not the transition distance is greater than a leveling distance, where the leveling distance is a current car position minus a transition position minus the transition distance.

19. The method of claim 18, wherein the step of providing the memory with the set of instructions further comprises providing the memory with instructions that when executed cause the processor to:
adjust the logarithmic averaging algorithm if the transition distance is greater than the leveling distance.

20. The method of claim 15, wherein the step of determining the slowdown position further comprises:
retrieving a car high speed from the motion sensor;
determining a slowdown distance average based on a slowdown sum accumulation variable, in the logarithmic averaging algorithm, and a slowdown sum factor;
scaling the slowdown distance average using the car high speed and a contract speed to derive a scaled slowdown distance average; and
determining the slowdown position based on the scaled slowdown distance average and the destination position.

21. The method of claim 20, providing the slowdown sum factor as an integer value of eight.

22. The method of claim 20, wherein the step of determining the slowdown distance average further comprises:
determining a leveling distance;
determining a slowdown distance;
adjusting the slowdown distance based on the target leveling time and a measured leveling time to determine an adjusted slowdown distance;
scaling the adjusted slowdown distance, based on the car high speed and the contract speed, to determine a scaled slowdown distance; and
determining the slowdown sum accumulation variable using the logarithmic averaging algorithm and the scaled slowdown distance.

23. The method of claim 22, wherein the step of determining the slowdown sum accumulation variable further comprises:
recursively filtering a slowdown sum by subtracting a logarithmic average of the slowdown distance from the slowdown sum and adding the scaled slowdown distance for each elevator run.

24. A method for controlling a hydraulic elevator, the hydraulic elevator including a car movably disposed in an elevator shaft, the car motivated by a hydraulic cylinder which is operatively connected to a hydraulic pump, the hydraulic pump controlled by a set of valves and powered by a motor, the car including a motion sensor reporting a car speed and a car shaft position, the method comprising:
providing a processor, including a memory;
providing a valve controller, operatively connected to the set of valves and the processor,
providing a motor controller, operatively connected to the motor and the processor;
providing a control panel, operatively connected to the processor; and
providing the memory with a set of instructions, that when executed cause the processor to:
receive a target leveling time;
receive a destination command to move the car to a destination position;
determine a direction of travel based on the destination command;
if the destination command is “up” then start the motor;
open a high speed valve, of the set of valves, and a slow speed valve, of the set of valves;
determine a slowdown position using a logarithmic averaging algorithm scaled by the target leveling time;
if the car is at the slowdown position, then deactivating the high speed valve;
monitoring a transition distance until the car reaches a leveling speed; and
deactivating the slow speed valve when the car reaches the destination position.

25. The method of claim 24, wherein the step of determining the slowdown position further comprises:
determining a slowdown distance logarithmic average; and
determining the slowdown position from the destination position and the slowdown distance logarithmic average.

26. The method of claim 25, wherein the step of providing the memory with the set of instructions further comprises providing the memory with instructions and when executed cause the processor to:
scale the slowdown distance logarithmic average by a high speed signal from the motion sensor and a contract speed.

27. The method of claim 26, wherein the step of determining the slowdown distance logarithmic average further comprises:
determining a slowdown distance;
adjusting the slowdown distance by a first ratio of the target leveling time to an actual leveling time, to determine an adjusted slowdown distance;
scaling the adjusted slowdown distance by a second ratio of the contract speed and the high speed signal, to determine a scaled slowdown distance; and
calculating a new slowdown sum from a previous slowdown sum, the slowdown distance logarithmic average and the scaled slowdown distance.

28. The method of claim 27, wherein the step of calculating further comprises:
doubling the scaled slowdown distance, if the transition distance is greater than a leveling distance.
